(19) United States
(12) Patent Application Publication
(10) Pub. No.: US 2015/0320262 A1
(43) Pub. Date: Nov. 12, 2015

(54) FROTHER, MIXER

(71) Applicants: Roberto STEFANONI, Oggiono, LC (IT); IDES DEVELOPMENT COMPANY LIMITED, Kowloon, Hong Kong (CN)

(72) Inventor: Roberto STEFANONI, Oggiono (IT)

(21) Appl. No.: 14/651,957

(22) PCT Filed: Dec. 12, 2012
(86) PCT No.: PCT/IT2012/000378

§ 371 Date: Jun. 12, 2015

(51) Int. Cl. A47J 43/046; A01J 11/16

(52) U.S. Cl. CPC A47J 43/046; A01J 11/16

(57) ABSTRACT

A device (1) for preparing emulsified milk, which is substantially cup-shaped and comprises:—a glass-like receptacle (2) receiving the milk to be emulsified;—an impeller (32) arranged within the receptacle (2) and driven by an electric motor (6);—a heating resistor (8) for heating the walls of the receptacle (2);—contacts (71, 72) for transmitting a power supply to the motor (6) and to the resistor (8);—a glass-like external casing (4) which hermetically houses the transmitting contacts (71, 72), hermetically connected with the receptacle (2) and it also substantially glass-shaped, wherein the device (1) is apt to be used by the user as a cup for drinking the prepared beverage

### TECHNICAL FIELD OF THE INVENTION

The present invention refers to a machine for preparing an emulsified beverage, for instance emulsified milk or a beverage based thereon, in particular a cappuccino, a chocolate or other.

### BACKGROUND

For preparing emulsified milk, some so-called “stand alone” devices exist for household use. Such devices are dedicated precisely to the preparing of whisked hot milk, in general intended for a subsequent mixing with coffee or other preparation so as to obtain a cappuccino, a hot chocolate, etc. Known devices considered herein provide a glass-shaped portion suitable to receive milk, onto the base thereof a resistor being arranged which produces thermal energy needed for the heating of the milk itself. Moreover, they incorporate a motor driving a stirrer arranged within said glass-shaped portion, so as to incorporate air in the milk and provide thereto the typical emulsified texture, i.e. of “cream” or froth.

Though appreciated for the good milk-whipping result attained, such devices entail some relevant drawbacks, and in particular:
being stand alone, they take up a non-negligible space and require an external power supply, separated from those of machines for preparing coffee or other infused beverage;
are very difficult to wash, since they have a non-sealed integrated electromechanical system not allowing, e.g., introduction in a washing machine;
after the emulsifying, the whisked milk has to be poured in a cup in order to drink it and/or add coffee, etc., and therefore beverage preparing is toilsome for the user;
are rather costly and delicate.

Moreover, machines for preparing beverages from a preparation in the form of infusion—e.g., tea, coffee, chocolate, etc.—are known which comprise, as integral parts thereof or as fittings, devices for preparing emulsified milk. Such further known devices provide the delivering of a jet of hot steam within a milk-receiving container. In such container it is moreover provided a rotating stirrer, mixing milk present in the container during steam delivering.

Also these devices can prove mechanically complex and difficult to clean.

### SUMMARY OF THE INVENTION

The technical problem set and solved by the present invention is therefore that of providing a device for preparing an emulsified beverage, in particular milk or a milk-based beverage, allowing to overcome the drawbacks mentioned above with reference to the known art.

Such a problem is solved by a device according to claim 1.

Preferred features of the present invention are object of the dependent claims.

In the present context, expressions such as “hermetic”, “hermetically” or “sealed” denote an imperviousness to fluids, in particular to liquids, and more in particular to water during washing operations.

The main advantage of the invention lies in that the device contrived is extremely compact, inexpensive and easy to use.

In particular, the device looks like a standard cappuccino cup and can be directly used as a container from which to drink by the end user, as well as a sole container for the emulsifying and the optional subsequent or concomitant mixing of the emulsified preparation with other ingredients, e.g. coffee.

The device is susceptible of being directly associated with a machine for preparing an infusion-based beverage—e.g. coffee, tea, chocolate, etc.—without requiring a separate power supply. Moreover, the device already lo comprises a stirrer for incorporating air in the beverage, and therefore such element does not have to be provided in the machine associated therewith.

Again, by virtue of its hermetic construction the device can be washed without difficulties also in a washing machine.

Other advantages, features and the operation modes of the present invention will be made apparent in the following detailed description of some embodiments thereof, given by way of example and not for limitative purposes.

### BRIEF DESCRIPTION OF THE FIGURES

Reference will be made to the figures of the annexed drawings, wherein:

FIG. 1 shows an exploded perspective view of a preferred embodiment of the device for preparing an emulsified beverage according to the present invention;

FIG. 2 shows a schematic perspective view of part of a machine for preparing beverages from a preparation in the form of infusion, in use with the device of FIG. 1, with a depiction partially in phantom lines to highlight some internal components;

FIG. 3 and FIG. 4 show respectively a longitudinal section view and a cross-section view of part of the device and of the machine of FIG. 2;

FIG. 5 shows a perspective view of an enlarged detail of some components visible in FIG. 2; and

FIG. 6 and FIG. 7 show each a perspective view of the machine of FIG. 2, respectively with and without the device of FIG. 1.

### DETAILED DESCRIPTION OF PREFERRED EMBODIMENTS

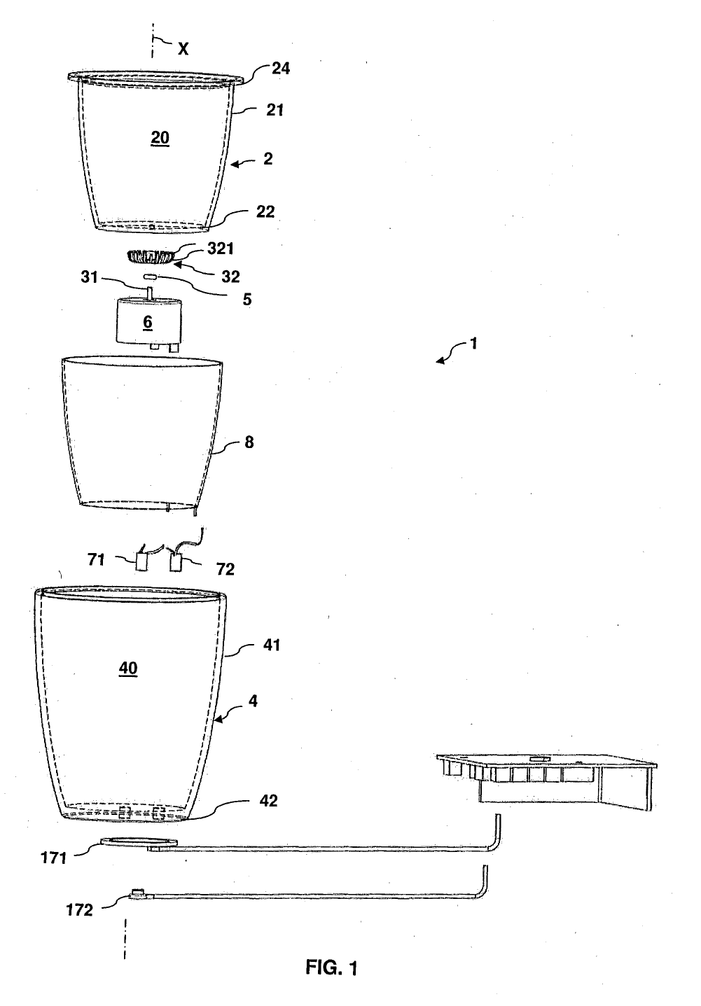

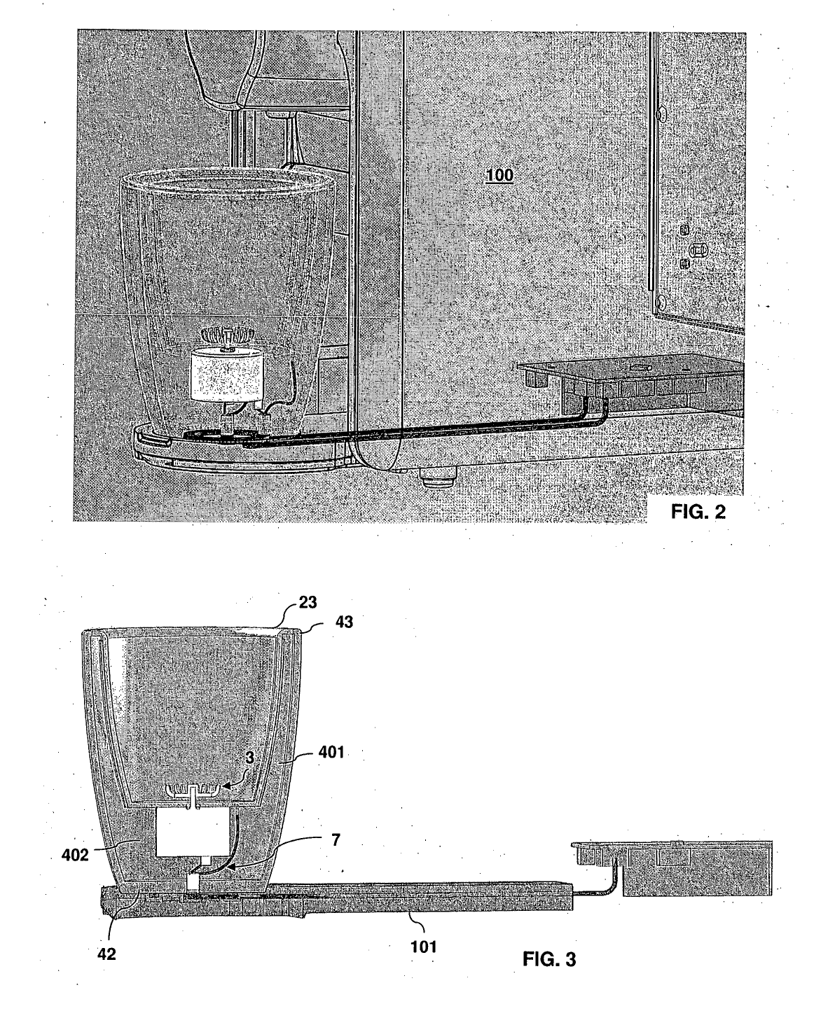

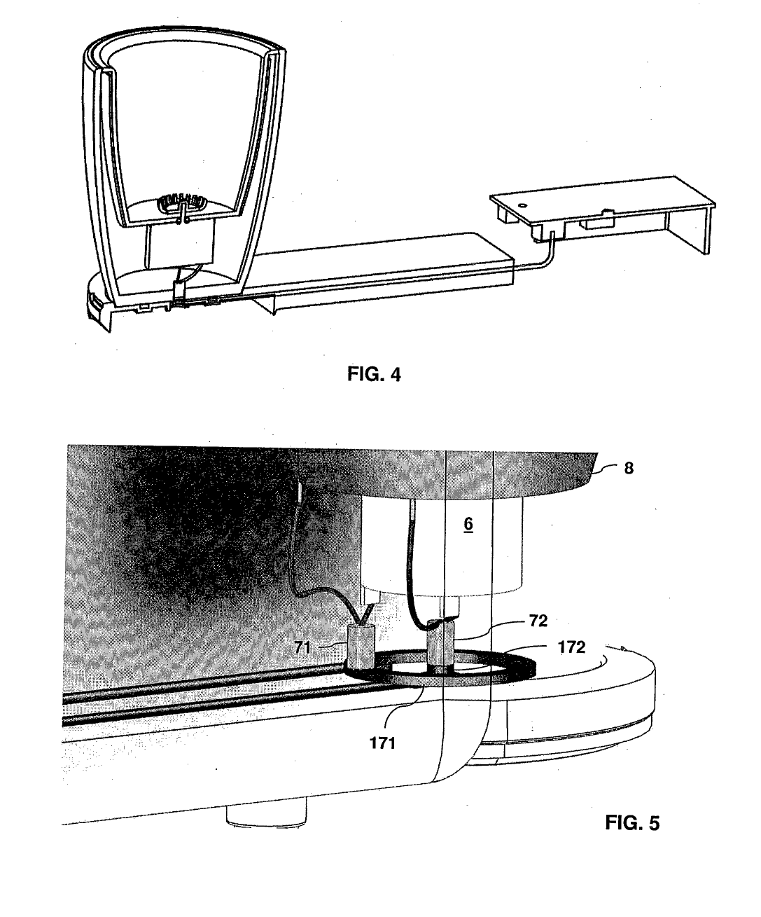

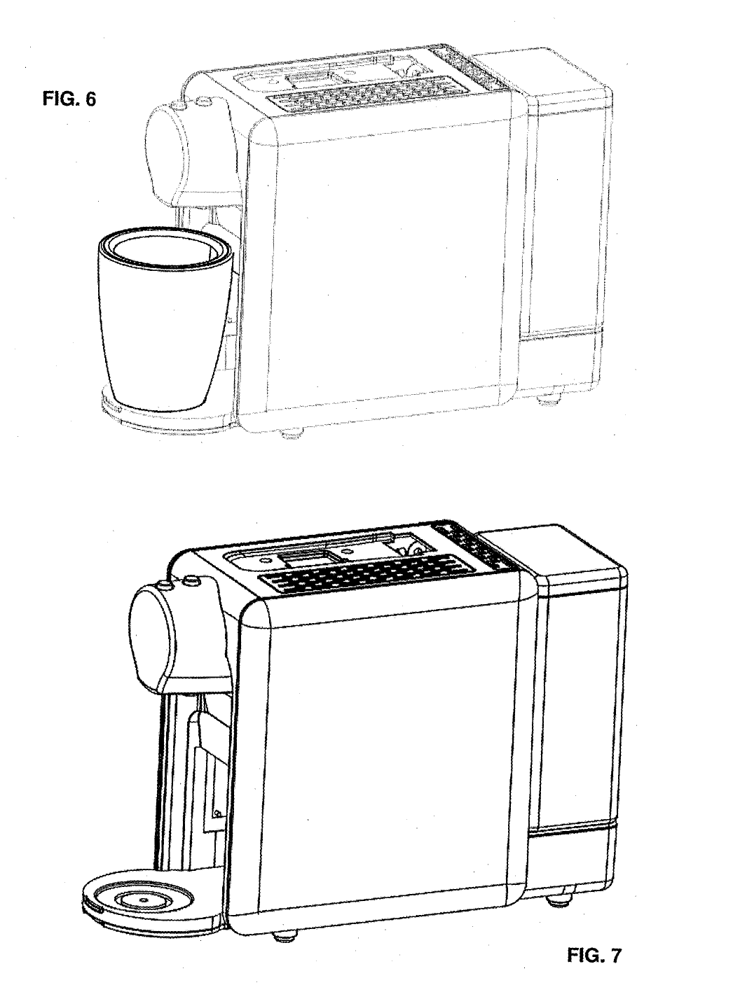

Referring initially to FIGS. 1 to 4, a device for preparing an emulsified beverage according to a preferred embodiment of the invention is globally denoted by 1.

In the present embodiment, the device 1 is intended for preparing emulsified milk. The device 1 of the present example is moreover contrived for use in a machine 100 for preparing beverages from a preparation in the form of an infusion, the latter typically provided in a disposable wafer or capsule. The machine 100 is in particular suitable for preparing coffee, tea, chocolate, cappuccino, herb teas and the like. In particular, machine-delivered coffee or other infusion is mixed with emulsified milk, prepared in the device 1, directly in the latter.

The device 1 is substantially cup-shaped and is precisely suitable to be used by the end user as a container from which to drink directly the prepared beverage.

The device 1 comprises a receptacle 2, substantially glass- or cup-shaped and suitable to receive the beverage to be emulsified. The receptacle 2 has a naturally convex configuration, defining a milk-receiving internal compartment denoted by 20. In the present example, the receptacle 2 has a side skirt 21 with a slightly convex profile and a bottom wall or base 22, preferably substantially plane. In the present example the receptacle 2 is of substantially circular geometry.

Preferably, the receptacle 2 is made of heat-resistant plastic, of course of food industry type, at least at the internal walls defining the compartment 20.

The bottom 22 of the receptacle 2 is crossed by a stem or shaft 31 of a stirrer 3, which stem extends substantially orthogonal to the bottom 22 itself, along an axis X. To guarantee hermetic sealing of the bottom 22 of the receptacle 2, and therefore avoid milk spillage, between stem 31 and bore of the bottom 22 crossed thereby a gasket 5, e.g. of O-ring type, or an equivalent sealing means is interposed.

The stirrer 3 bears an impeller 32 fixed to the stem 31, arranged just within the internal compartment 20 of the receptacle 2 so that, by rotating about the axis X, it may foster air incorporation into milk.

In the present example, the impeller 32 has a plurality of arms 321, each extending radially with respect to the stem 31 and each having a curved end portion, defining a substantially flower-like overall shape of the impeller 32.

Therefore, the impeller 32 defines an emulsifying whisk.

The device 1 further comprises means for heating the receptacle 2, and therefore the milk received, in use, therein. Preferably, the heating means is suitable to heat a part or all of the side skirt 21 and/or the bottom 22.

In the present example, the heating means is suitable to heat substantially the entire side skirt 21 of the receptacle 2. To this end, advantageously said means comprises a resistor 8 of flexible type, having a configuration substantially following that of the side skirt 21 itself. Such resistor 8 may be obtained by silk screen-type techniques.

The resistor 8 is made fixed to the receptacle 2 precisely at the side skirt 21 thereof, integrally covering it.

Variant embodiments may provide the resistor—or a heating means alternative thereto—to be wound coil-like on the side skirt of the receptacle and be optionally supported on a coating of the receptacle itself reproducing the shape of such side skirt. On the basis of another variant, the resistor or an alternative heating element may be incorporated in the actual receptacle 2.

The device 1 moreover comprises an external casing 4, which in the present embodiment is it also substantially glass- or cup-shaped. In particular, the casing 4 has a naturally convex configuration, defining an internal compartment globally denoted by 40. In the present example the casing 4 has a side skirt 41 having a slightly convex profile and a bottom wall or base 42, preferably substantially plane. The casing 4 has it also a substantially circular geometry.

In the present example, the casing 4 and the receptacle 2 are both substantially to longitudinally symmetrical to their own longitudinal axis, in particular identifiable with the above-mentioned axis X.

The casing 4 is arranged circumscribed to the receptacle 2, in particular coaxially thereto along axis X.

The external casing 4 and the receptacle 2 are hermetically connected at respective inlets, respectively denoted by 43 and 23, i.e., they are connected at a peripheral edge of the cup-shaped device 1 defining the inlet at which the user rests the lips to drink the beverage. Precisely at such inlet 23 the receptacle 2 has an externally projecting edge, or ledge, 24, at which it is hermetically connected, e.g. welded, to the casing 4. In particular, an ultrasound or hot-blade welding process may be adopted. In general, the external casing 4 and the internal receptacle 2 constitute a single block, impermeable and made fixed.

Between the side skirt 41 of the casing 4 and the side skirt 21 of the receptacle 2, a compartment or space 401 remains defined, in particular having a substantially toric geometry. Such (air) space 401 carries out a thermal insulation of the receptacle 2 heated by the heating means 8, and therefore allows to keep the beverage received therein hot and concomitantly generally cooler the external part of the casing 4 in contact with the user's hand. Therefore, the device 1 of the present example is also a so-called thermal cup.

Moreover, below the bottom 22 of the receptacle 2 and between the latter and the bottom 42 of the casing 4 a space or compartment 402 remains defined.

In the present example, the device 1 further comprises driving means for driving the impeller 32, means which in the present example comprises an electric motor 6 (preferably of low-voltage type), which drive shaft coincides with or is connected to the stem 31. The motor 6 is arranged immediately adjacent to the bottom 22 of the receptacle 2, externally to the latter and therefore in the space 402.

Variant embodiments may provide that the driving means be arranged at least partially externally to the device 1, and therefore e.g. directly associated at least partly to the machine 100, and in particular to a base thereof.

The device 1 moreover comprises means for transmitting a drive to the motor 6, and therefore to the stirrer 3, and to the heating means 8. Such transmitting means, globally denoted by 7, is hermetically housed within the device 1, in particular at the external casing 4, at least partly within the bottom compartment 402.

In the present example, such transmitting means is means for transmitting a power supply both to the heating means 8 and to the motor 6, and is therefore connected to the latter by known modes, typically by cables.

As best seen in FIGS. 3 and 5, in the present example the transmitting means 7 comprises electric contact elements integrated at the bottom 42 of the external casing 4, preferably co-moulded therewith. In general terms, the arrangement of the transmitting means 7 is such that a preferably electric power supply contact may be established, through the bottom 42 of the casing 4, maintaining the overall hermetic sealing of the device 1, and in particular of the compartment 402 interposed between receptacle 2 and external casing 4.

Preferably, two contact elements are provided, in particular a first element 71 and a second element 72, each connected, e.g. by respective power cables, both to the heating means 8 and to the motor 6. Such two contact elements 71 and 72 correspond to the two power supply polarities.

The machine 100 comprises means for power-supplying the device 1 which, in use, is in communication with the transmitting means 7. In particular, in the present example a first and a second power supply contact are provided, respectively denoted by 171 and 172, suitable to be coupled respectively with the first and second contact 71 and 72 according to respective polarities. Preferably, the first power supply contact 171 is in the form of a circular crown and the second power supply contact 172 is in the form of a small plate, e.g. m circular, extending through the internal space of the first power supply contact 171.

Therefore, the overall arrangement is such that the power supply can be transferred from the machine 100 to the active components of the device 1 by a mere resting of the device 1 on a base 101 of the machine 100 receiving the power supply contacts 171 and 172.

Advantageously, the active components integrated in the cup-shaped device 1, i.e., as said, the driving means 6 and the heating means 8, are power-supplied at a low voltage, 12-24 Volts. Throughout the unit, power supply arrives from the contact elements of the machine 100 and, it being an insulated low voltage, no shieldings of the power supply contacts themselves are necessary.

Preferably, the machine 100 also comprises control means suitable to recognize the cup-shaped device 1 when the latter is arranged on the base 101 of the machine itself, so as to activate the active components thereof, i.e. the stirrer 32 via the driving means 6 and the heating means 8.

Preferably, such control means is also suitable to distinguish different devices 1, e.g. as associated with different users, and in particular to discriminate different pre-programmed functions associated with the specific device. In this connection, the device 1 may bear identification means, e.g. in the form of an electronic storage element with wireless transmitting means, e.g. an RFID tag, suitable to allow such identification.

It will be better appreciated by now that the device of the invention, particularly in the above-described embodiment example, bears therein the bare minimum of components required to ensure an optimum result in preparing the beverage. In practice, the power-supply and security components are transferred inside the machine.

Moreover, the device is susceptible to be manufactured with low-cost and high-tech production components. Therefore, the cost of production and sale of the device can be very low, allowing a quick and inexpensive replacement in case of failure.

The use of the device is very easy for the user, who has just to handle a single cup—i.e. the device of the invention—and carry out a single operation, which is that of putting the cup with the milk (if desired, also with sugar that would be mixed in) directly under the coffee outlet of the machine. Concomitantly, or after the emulsifying, the machine can deliver coffee or other infusion directly into the milk-containing cup-shaped device 1.

In a nutshell, the device is very economical and of intelligent interface with a pre-arranged machine.

The present invention has been hereto described with reference to preferred embodiments thereof. It is understood that other embodiments might exist, all falling within the concept of the same invention, as defined by the protective scope of the claims hereinafter.

1. A device for preparing an emulsified beverage, which device is substantially cup-shaped and comprises:
a glass-like receptacle suitable to receive a beverage to be emulsified;
a stirrer arranged within said receptacle;
a heater of said receptacle;
a transmitter of a power supply, in particular electric, to said stirrer and to said heater, which transmitter is suitable to receive a power supply from the outside; and
an external casing which hermetically houses said transmitter and is hermetically connected with said receptacle;
the overall arrangement being such that said device is configured to be used by a user as a cup for drinking the prepared beverage.

2. The device according to claim 1, wherein said external casing is substantially cup- or glass-shaped and arranged circumscribed to said receptacle.

3. The device according to claim 1, wherein said receptacle and said external casing are arranged along a same longitudinal axis coaxially with respect to each other.

4. The device according to claim 1, wherein between said external casing and said receptacle a compartment or hollow space is defined, suitable as thermal insulation of said receptacle with respect to the external environment.

5. The device according to claim 4, wherein said external casing and said receptacle are hermetically connected at respective inlets.

6. The device according to claim 1, wherein the arrangement of said transmitter is such that, in use, a supply contact, preferably an electric power supply contact, is established through said casing (4), maintaining overall hermetic sealing of the device.

7. The device according to claim 6, wherein said transmitter has electric contacts integrated at a base or bottom of said external casing, preferably co-moulded with said external casing.

8. The device according to claim 1, wherein said heater is arranged so as to heat at least one wall of said receptacle.

9. The device according to claim 1, wherein said heater is arranged so as to heat at least part of a side skirt of said receptacle.

10. The device according to claim 1, wherein said heater is arranged substantially circumscribed to said receptacle, being preferably shaped so as to reproduce the external profile of at least part of said receptacle.

11. The device according to claim 1, wherein said heater comprises a resistor, preferably flexible and/or preferably obtained by silk-screen techniques.

12. The device according to claim 1, further comprising a driver of said stirrer, hermetically received within said casing, which driver preferably comprises an electric motor.

13. A machine for delivering beverages from a preparation in the form of infusion, suitable for use with a device according to claim 1, which machine comprises a power supply for said device which, in use, is in communication with said transmitter, which power supply preferably comprises one or more power supply contacts preferably arranged at a base of said machine.

14. The machine according to claim 13, wherein said one or more power supply contacts of said machine are suitable to transmit the power supply to said transmitter of said device by a mere resting of the device on said one or more contacts.

15. The machine according to claim 13, further comprising a controller suitable to recognize said cup-shaped device and to activate a related power supply.

16. The machine according to any claim 13, further comprising a driver for said stirrer, which driver preferably comprises an electric motor.

17. The device according to claim 1, wherein said beverage is milk.

18. The machine according to claim 13, wherein said infusion is coffee, tea, or chocolate.
